(19) United States
(12) Patent Application Publication
(10) Pub. No.: US 2012/0146982 A1
(43) Pub. Date: Jun. 14, 2012

(54) LIQUID CRYSTAL DISPLAY DEVICE AND CONTROL METHOD

(75) Inventor: Yuji Ueno, Inagi (JP)

(73) Assignee: FUJITSU FRONTECH LIMITED, Tokyo (JP)

(21) Appl. No.: 13/398,220

(22) Filed: Feb. 16, 2012

Related U.S. Application Data
(63) Continuation of application No. PCT/JP2009/006410, filed on Nov. 26, 2009.

(51) Int. Cl. G09G 5/00

(52) U.S. Cl. 345/211

(57) ABSTRACT

A method of controlling a liquid crystal display device which is used for color display and can reduces cross talk noise with a simple configuration. The control method of the liquid crystal display panel which includes three liquid crystal display panels of simple matrix, and a plurality of driver units, provided as associated with the plurality of liquid crystal display panels, to apply a driving voltage to the liquid crystal display panels, the method includes inverting by a inverter a pulse polarity control signal for converting a driving voltage applied to the liquid crystal display panels by the driver units to an alternative current voltage, and inputting the inverted signal to the driver unit corresponding at least one of the plurality of liquid crystal display panels.

### CROSS-REFERENCE TO RELATED APPLICATIONS

This application is a continuation application of International PCT Application No. PCT/JP2009/006410, filed on Nov. 26, 2009, the entire contents of which are incorporated herein by reference.

### FIELD

The present invention relates to a liquid crystal display device of simple matrix, and more specifically to a method of driving the driving voltage of a liquid crystal panel.

### BACKGROUND

A simple matrix system is known as a liquid crystal display panel system.

The liquid crystal display panel by the simple matrix system is widely used in a simple display device, an intermediate display device, etc. because it is produced in a relatively simple process at a low production cost. In addition, it is expected that a thin and light device is realized with very low power consumption at a low price by using as an electronic paper a liquid crystal display panel of simple matrix in which a cholesteric liquid crystal is used. As for the electronic paper, a color display realized by stacking a plurality of liquid crystal display panels has been studied.

Generally, when one equipment unit includes a plurality of liquid crystal display panels, the equipment unit is configured so that all signals except a data signal and several types of voltages required to drive a selection voltage, a non-selection voltage, etc. are supplied from a single power supply in order to operate the equipment unit. With the configuration, the number of control signals can be reduced, and the size of the control circuit can also be reduced.

However, if all signals to be added to the liquid crystal display panels are to be operated with the same timing, and when the necessary voltage is biased, the currents of a plurality of display panels are required simultaneously. For example, a non-selection signal has the same voltage except for one selected line. In this case, the voltage drop of the power supply voltage increases, thereby causing an unstable power supply voltage.

If the power supply voltage becomes unstable, the potential difference develops, and flicker occurs (a voltage is applied to an unexpected pixel, which operates the liquid crystal), thereby displaying unexpected portion and darkening the entire liquid crystal display screen, that is, causing a cross talk.

A countermeasure against an occurrence of the cross talk can be the methods of the following patent documents 1 through 7.

The patent document 1 describes a method of driving an information display device capable of suppressing the reduction of the contrast caused by a cross talk voltage on the simple matrix panel. In the patent document 1, the information display device applies multiple pulses during one pixel rewrite and adjusts a drive waveform for suppressing a change in polarity of the voltage applied to a non-rewrite pixel during one pixel rewrite.

The patent document 2 discloses a liquid crystal display device for minimizing the increase of a circuit part and decreasing the cross talk. The liquid crystal display device disclosed by the patent document 2 intends to decrease the cross talk by applying a correction voltage to the driving voltage of a liquid crystal.

The patent document 3 discloses a liquid crystal display device for suppressing an increasing cross talk caused by a waveform distortion occurring during electric charge and discharge on a liquid crystal layer. The liquid crystal display device disclosed by the patent document 3 corrects an applied voltage by adding a correction voltage pulse, and adjusts the application time of the correction voltage pulse for each scanning electrode.

The patent document 4 discloses a high-quality and small liquid crystal display device for more easily suppressing the cross talk caused by a distortion of an applied voltage to the liquid crystal panel while fulfilling the downsizing. In the liquid crystal display device disclosed by the patent document 4, when the applied voltage to the liquid crystal panel is changed from a selection level to a non-selection level, the applied voltage is set up to a substantially median potential between both levels in the specified time, and the scanning side applied voltage is placed in a non-selection level within the specified time.

The patent document 5 discloses a liquid crystal display device for correcting the increase of an effective voltage by cross talk noise caused on the non-selection voltage of a common driver by a change in output of a segment driver. In the liquid crystal display device of the patent document 5, when a white or black background is displayed, the rising and falling edge noise of the segment driver output signal at the change point of the output signal of the segment driver is detected as the amount of cross talk noise to be propagated to common driver output waveform, respectively. The amount of cross talk noise is output to the driver as a correction pulse signal of the driver output, and it is determined on the driver side whether or not the same data as the background data is output, and when the data which is not the same as the background is output, the output voltage is not output for the width of the correction pulse signal, and any voltage is output.

The patent document 6 discloses a liquid crystal display device to reduce the cross talk. The liquid crystal display device of the patent document 6 provides a pulse for the applied voltage as with the display device according to the patent document 3, and suppresses a distortion by adjusting the time in which the pulse is applied.

The patent document 7 describes a liquid crystal display device for high quality display by offsetting the cross talk with a correction voltage. In the patent document 7, in order to adjust the voltage, if there is a smaller number of lighting signals to be supplied to the currently selected scanning line than the number of the lighting signals to be supplied to the scanning line immediately before, the scanning line non-selection bias voltage is set low. If there are a larger number of the signals, the scanning line non-selection bias voltage is set high. If there are an equal number of the signals, the current bias voltage is to be maintained.

The liquid crystal display devices disclosed in the patent documents 1 through 7 aim at improving the cross talk, and are intended to reduce the cross talk by adding a correction voltage to an applied voltage in any method. Therefore, the configuration requires generating a correction voltage, thereby producing a large device with a complicated configuration. Furthermore, a device for color display realized by combining a plurality of liquid crystal display panels is not considered.

### DOCUMENTS OF PRIOR ART

### Patent Documents

[Patent Document 1] Japanese Laid-open Patent Publication No. 2005-331936

[Patent Document 2] Japanese Laid-open Patent Publication No. 11-002796

[Patent Document 3] Japanese Laid-open Patent Publication No. 10-254416

[Patent Document 4] Japanese Laid-open Patent Publication No. 10-239666

[Patent Document 5] Japanese Laid-open Patent Publication No. 10-020275

[Patent Document 6] Japanese Laid-open Patent Publication No. 6-051271

[Patent Document 7] Japanese Laid-open Patent Publication No. 5-210367

### SUMMARY

The present invention aims at providing a liquid crystal display device which accommodates color display and can realize reduction of cross talk noise with a simple configuration, and its control method.

According to an aspect of the invention, a liquid crystal display device includes a plurality of liquid crystal display panels of simple matrix; a plurality of driver units, provided as associated with the plurality of liquid crystal display panels, to apply a driving voltage to the liquid crystal display panels; a control unit to output a pulse polarity control signal (FR) for converting a driving voltage applied to the liquid crystal display panels by the driver unit to an alternative current voltage; and an inverter unit to invert the pulse polarity control signal (FR) output by the control unit and to input the inverted signal to the driver unit corresponding to at least one of the plurality of liquid crystal display panels.

According to an aspect of the invention, a control method for a liquid crystal display device including a plurality of liquid crystal display panels of simple matrix, and a plurality of driver units, provided as associated with the plurality of liquid crystal display panels, to apply a driving voltage to the liquid crystal display panels, the method includes inverting a pulse polarity control signal (FR) for converting the a driving voltage applied to the liquid crystal display panels by the driver units to an alternative current voltage; and inputting the inverted signal to the driver unit corresponding to at least one of the plurality of liquid crystal display panels.

### BRIEF DESCRIPTION OF DRAWINGS

FIG. 1A is an example of a configuration of the liquid crystal display device according to an embodiment of the present invention;

FIG. 1B is an example of a configuration of the liquid crystal display device according to an embodiment of the present invention;

FIG. 2A is a view (1) of a selected line and a nonselected line in the liquid crystal display panel;

FIG. 2B is a view (2) of a selected line and a nonselected line in the liquid crystal display panel;

FIG. 3 is an example of a signal added to the liquid crystal display panel according to an embodiment of the present invention;

FIG. 4 illustrates the voltage level in the segment (SEG) side and the common (COM) side in the cases (1) through (4); and

FIG. 5 illustrates a drop and a rise of a voltage in the cases (3) and (4) when the three liquid crystal display panels of red (R), green (G), and blue (B) are displayed synchronously.

### DESCRIPTION OF EMBODIMENTS

An embodiment of the present invention is described below in detail with reference to the attached drawings.

The liquid crystal display device according to the present embodiment is configured to perform color display by stacking liquid crystal display panels of simple matrix in which cholesteric liquid crystals of three colors of red (R), green (G), and blue (B) are used. The liquid crystal display device according to the present embodiment is not limited to the device in which liquid crystal display panels of three colors are combined, but the device in which two liquid crystal display panels are combined, and the device in which four or more liquid crystal display panels are combined. In addition, the color of the liquid crystal display panel is not limited to red (R), green (G), or blue (B). Other colors of liquid crystal display panels can be used.

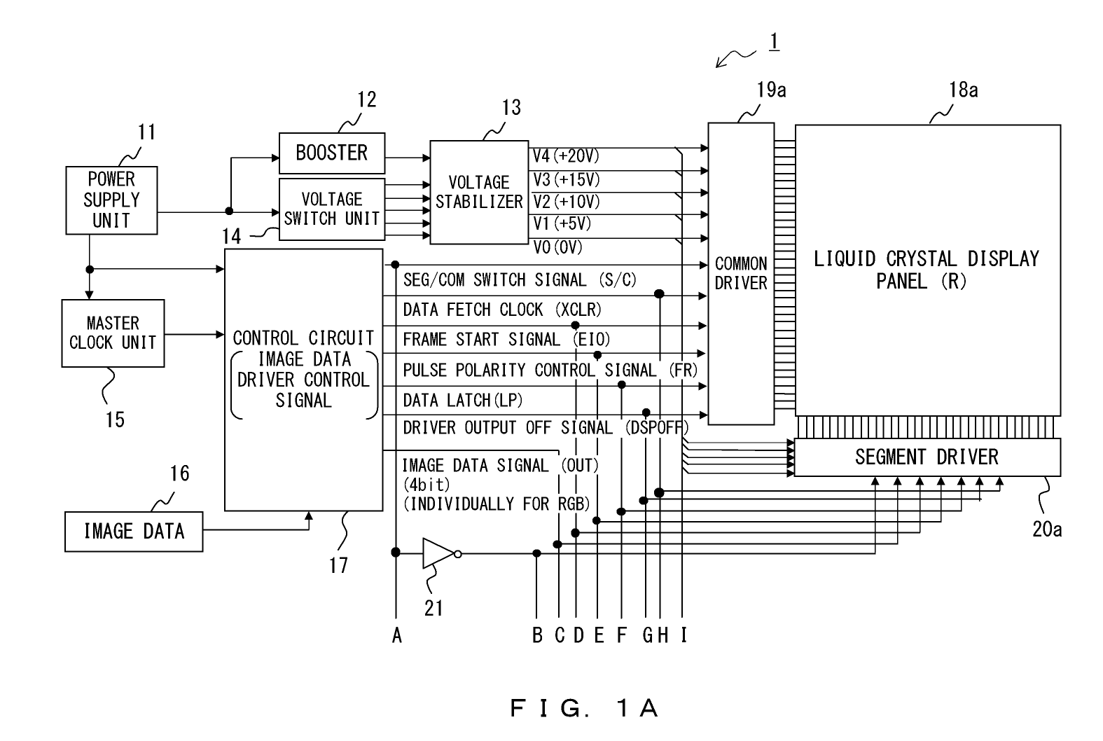

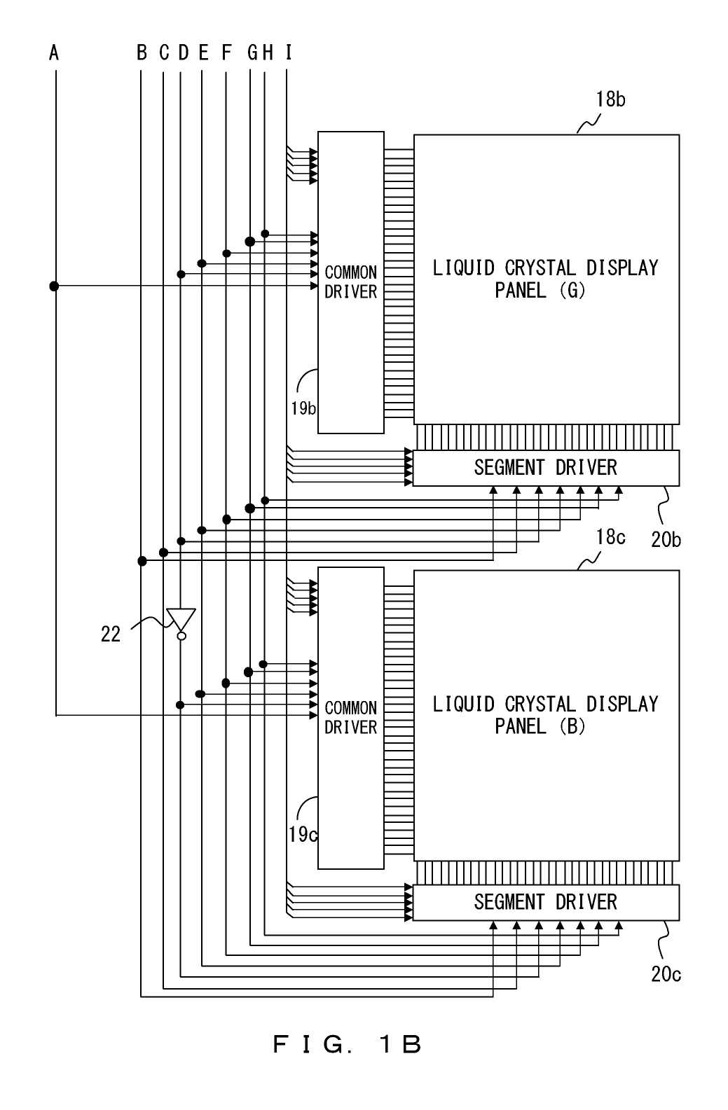

FIG. 1A and FIG. 1B are an example of a configuration of the liquid crystal display according to the present embodiment.

A liquid crystal display device 1 according to the present embodiment includes three liquid crystal display panels 18a, 18b, and 18c of simple matrix of red (R), green (G), and blue (B) which are stacked in such a way that the positions of each of the electrodes of the liquid crystal display panels match each other, and performs color display according to image data 16 input externally.

The liquid crystal display device 1 according to the present embodiment also includes a power supply unit 11, a booster 12, a voltage stabilizer 13, a voltage switch unit 14, a master clock unit 15, a control circuit 17, and inverters 21 and 22.

The power supply unit 11 supplies power to the liquid crystal display device 1. The booster 12 raises the output voltage of the power supply unit 11 up to the necessary voltage value to drive the liquid crystal display panels 18a, 18b, and 18c. The voltage stabilizer 13 generates voltage values V0, V1, V2, V3, and V4 to be supplied to common drivers 19a through 19c and segment drivers 20a through 20c by using the output voltage from the booster 12, and outputs them to each of the common drivers 19a through 19c and the segment drivers 20a through 20c. The voltage values V0 through V4 refer to, for example, 0V, +5V, +10V, +15V, and +20V respective. The voltage switch unit 14 generates correction values required when the voltage stabilizer 13 generates the voltage values V0 through V4, and outputs them to the voltage stabilizer 13. The master clock unit 15 outputs a clock signal according to which the liquid crystal display device 1 is driven. The control circuit 17 controls the display of the entire liquid crystal display device 1, and outputs data signals and control signals from the clock signal of the master clock unit 15 and the externally input image data 16 to the common drivers 19a through 19c and the segment drivers 20a through 20c.

FIG. 1A and FIG. 1B illustrate as control signals output by the control circuit 17 a SEG/COM switch signal (S/C), a data fetch clock (XCLR), a frame start signal (EIO), a pulse polarity control signal (FR), a data latch signal (LP), a driver output off signal (DSPOFF), and an image data signal (OUT). The SEG/COM switch signal (S/C) is a signal for switching between the application of a signal by the common driver 19 and the application of a signal by the segment driver 20. The data fetch clock (XCLR) is a clock signal for acquiring a signal applied to each of the liquid crystal display panels 18a through 18c. The frame start signal (EIO) is a signal used to control the operation order of each driver device when each of the common drivers 19a through 19c and the segment drivers 20a through 20c are configured by a plurality of driver devices, respectively. The frame start signal (EIO) is not necessary when each of the common drivers 19a through 19c and the segment drivers 20a through 20c are configured by one driver device, respectively. The pulse polarity control signal (FR) is a signal for reversing the signal to be applied to each of the liquid crystal display panels 18a through 18c and converting it to an alternating current voltage. The details of the pulse polarity control signal (FR) are described later. The data latch signal (LP) is a signal as a trigger of determining the timing of outputting one line of data. The driver output off signal (DSPOFF) is a signal for switching the ON/OFF state of the output of the common drivers 19a through 19c and the segment drivers 20a through 20c. The image data signal (OUT) is 4-bit data for directing the ON/OFF state of each pixel of the liquid crystal display panels 18. The image data signal (OUT) refers to an individual value of red (R), green (G), and blue (B).

Among these signals, the SEG/COM switch signal is input as is to the common drivers 19a through 19c, and is inverted and input to the segment drivers 20a through 20c through the inverter 21.

The pulse polarity control signal (FR) is input as is to the common drivers 19a of red (R) and 19c of blue (B), and the segment drivers 20a and 20c, and is inverted and input to the common driver 19b and the segment driver 20b of the liquid crystal display panel 18c of blue (B), which has the largest capacitance in the three liquid crystal display panels 18a through 18c, through the inverter 22. This process is described later.

The liquid crystal display panel 18 of simple matrix sequentially selects one display line on the common (COM) side, and applies the voltage indicating the ON (H)/OFF (L) of each pixel of the selected line from the segment (SEG) side, thereby performing the display. Therefore, the common driver 19 on the common (COM) side indicates a higher rate for the unselected (low) line than the selected (high) line, and the most of the area in the liquid crystal display panel 18 indicates an unselected area.

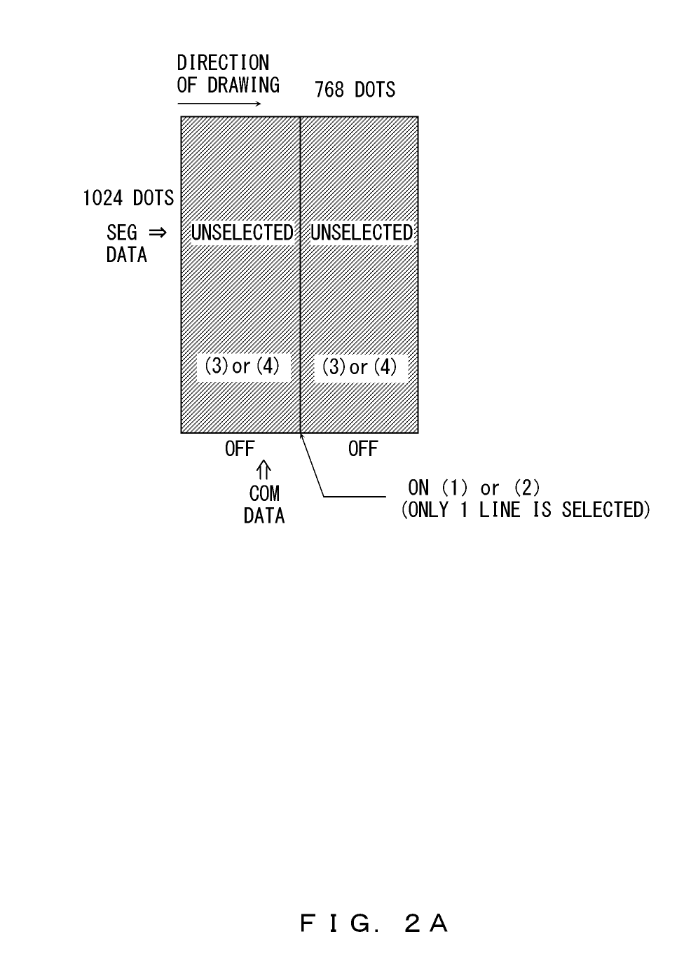

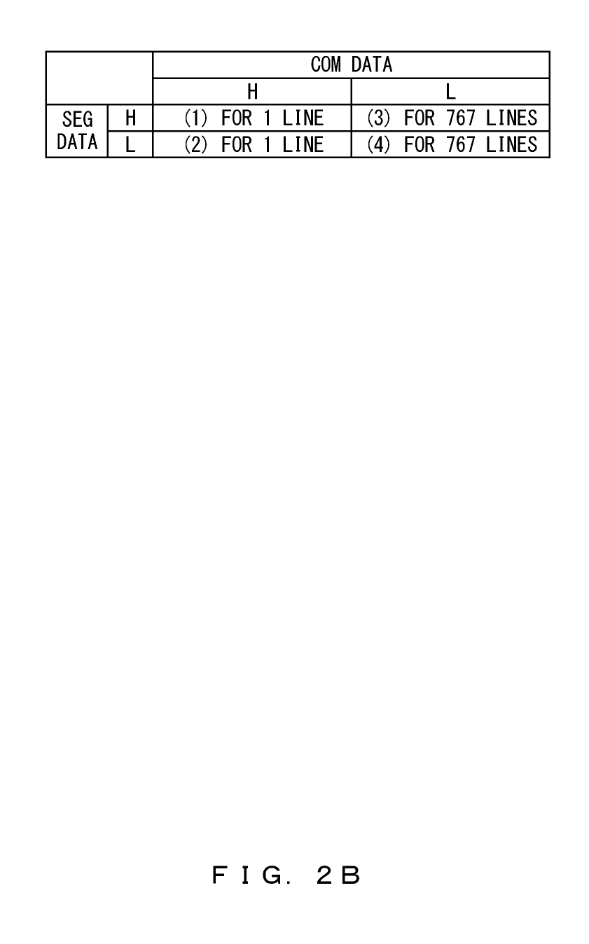

FIGS. 2A and 2B illustrate the state as described above. FIGS. 2A and 2B are examples of the liquid crystal display screen of simple matrix of the size of 768×1024 of XGA.

In FIG. 2A, on the common (COM) side, one line in the 768 lines is selected, and the other 767 lines are unselected. On the entire screen, the lines other than one selected line are unselected.

Therefore, as illustrated in FIG. 2A, the one selected line on the common (COM) side refers to (1) (when SEG data is H) or (2) (when SEG data is L) in FIG. 2B, and the other 767 unselected lines refer to (3) (when SEG data is H) or (4) (when SEG data is L).

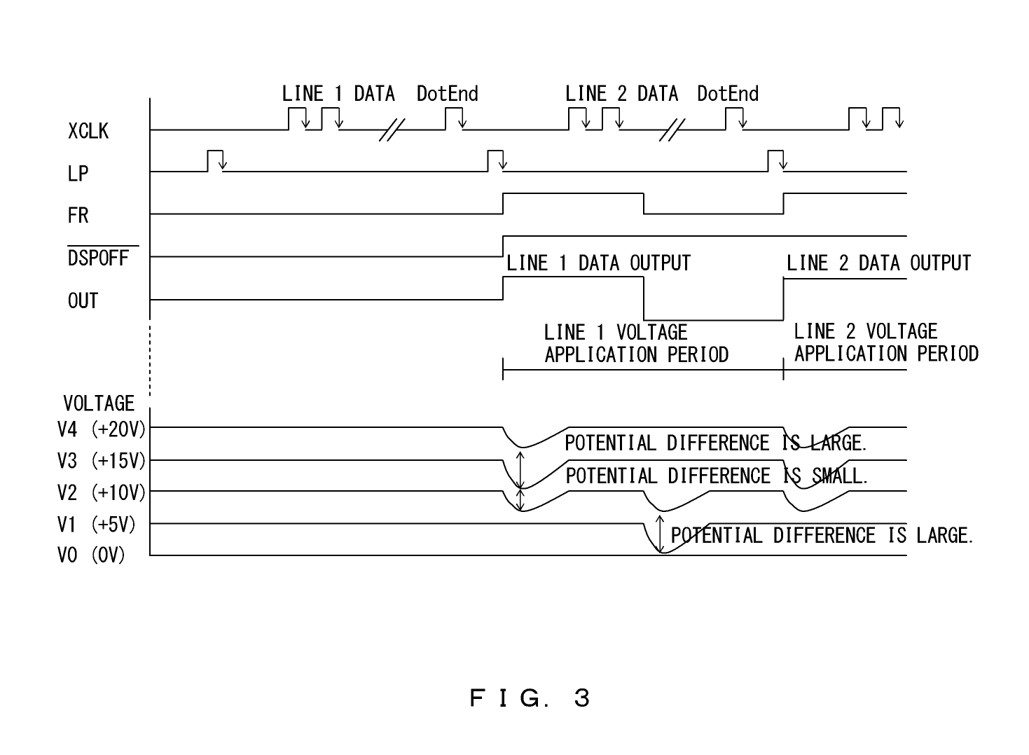

FIG. 3 is an example of a signal applied to the liquid crystal display panel according to the present embodiment.

FIG. 3 illustrates as signals to be applied to the liquid crystal display panel 18 the data fetch clock (XCLR), the data latch signal (LP), the pulse polarity control signal (FR), the driver output off signal (DSPOFF), and the image data signal (OUT).

As illustrated in FIG. 3, the OUT signal changes according to the pulse polarity control signal (FR) as a trigger. Therefore, when the pulse polarity control signal (FR) is changed, the voltage on the segment (SEG) side mostly refers to an unselected value as illustrated in FIG. 2.

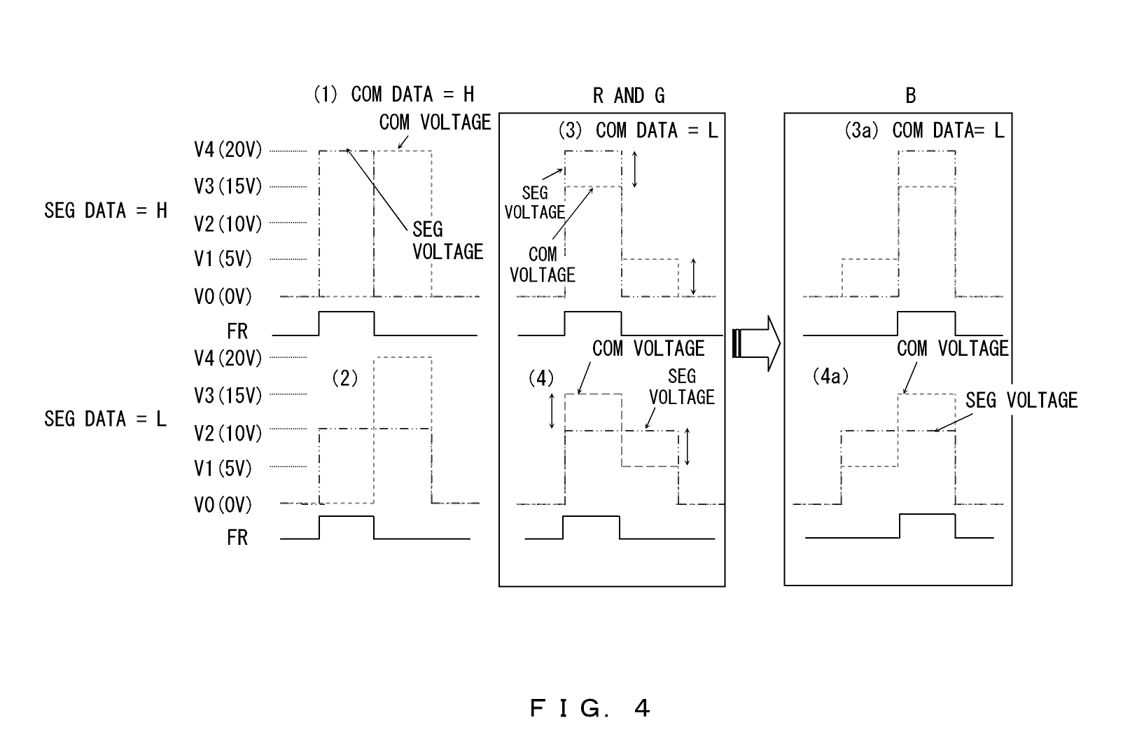

FIG. 4 illustrates the voltage level on the segment (SEG) side and the common (COM) side in the cases (1) through (4) illustrated in FIG. 2B.

FIG. 4 illustrates the voltage (SEG voltage) on the segment (SEG) side and the voltage (COM voltage) on the common (COM) side in the case (1) in which both of the segment (SEG) side and the common (COM) side indicate “H”, in the case (2) in which the segment (SEG) side indicates “L” and the common (COM) side indicates “H”, in the case (3) in which the segment (SEG) side indicates “H” and the common (COM) side indicates “L”, and in the case (4) in which both of the segment (SEG) side and the common (COM) side indicate “L”. The dotted line waveform refers to the voltage waveform on the COM side, and the alternate long and two dashed short line refers to the voltage waveform on the SEG side.

In the liquid crystal display panel 18, an alternating current (AC) voltage is used as the applied voltage to prevent from the degradation of the characteristic by the destruction of the pixels forming part of the liquid crystal. The invert of the applied voltage is performed by using the pulse polarity control signal (FR) as a trigger.

When the COM data indicates “H” and the SEG data indicates “H” in the case (1) illustrated in FIG. 4, the SEG voltage indicates V4 and the COM voltage indicates V0 in the period in which the pulse polarity control signal (FR) indicates “H.” In the period in which the pulse polarity control signal (FR) indicates “L”, the SEG voltage changes into V0, and the COM voltage also changes into V4.

When the COM data indicates “H” and the SEG data indicates “L” in the case (2) illustrated in FIG. 4, the SEG voltage indicates V2 and the COM voltage indicates V0 in the period in which the pulse polarity control signal (FR) indicates “H.” In the period in which the pulse polarity control signal (FR) indicates “L”, the SEG voltage remains unchanged as V2, but the COM voltage changes into V4.

When the COM data indicates “L” and the SEG data indicates “H” in the case (3) illustrated in FIG. 4, the SEG voltage indicates V4 and the COM voltage indicates V3 in the period in which the pulse polarity control signal (FR) indicates “H.” In the period in which the pulse polarity control signal (FR) indicates “L”, the SEG voltage changes into V0, and the COM voltage also changes into V1.

When the COM data indicates “L” and the SEG data indicates “L” in the case (4) illustrated in FIG. 4, the SEG voltage indicates V2 and the COM voltage indicates V3 in the period in which the pulse polarity control signal (FR) indicates “H.” In the period in which the pulse polarity control signal (FR) indicates “L”, the SEG voltage remains unchanged as V2, and the COM voltage changes into V1.

As illustrated in FIG. 2, since most lines are unselected on the common (COM) side, the SEG voltage and the COM voltage are expressed as (3) or (4) in FIG. 2. For example, when an image of black characters written with a white background is drawn, the pattern (4) is obtained because most of the segment data is white data (L data). Therefore, on the common (COM) side, the voltage value of V3 (V1 in the case of the pattern (3)) is to be applied in the 2301 (767×3) signal lines.

Since the liquid crystal display panel 18 electrically functions as a capacitor, a voltage drop occurs in the power supply voltage when such a large number of signal lines are set as one voltage value.

Therefore, as illustrated in the lower column in FIG. 2, since V3 is selected in a number of signal lines as a COM voltage at the rising edge of the pulse polarity control signal (FR), the potential of V3 considerably drops, thereby slightly dropping the potential of V1 and V4 which are selected in the minority, but not changing V0 and V1 which are not selected at all. At the falling edge of the pulse polarity control signal (FR), since V1 is selected in a number of signal lines as a COM voltage, the potential of V1 considerably drops, thereby slightly dropping the potential of V2 which is selected in the minority, but not changing V0, V3, and V4 which are not selected at all.

Therefore, at the rising edge of the pulse polarity control signal (FR), the potential difference between V2 and V4 becomes smaller while the potential difference between V3 and V4 develops. Likewise, at the falling edge of the pulse polarity control signal (FR), the potential difference between V0 and V1 becomes smaller while the potential difference between V1 and V2 develops.

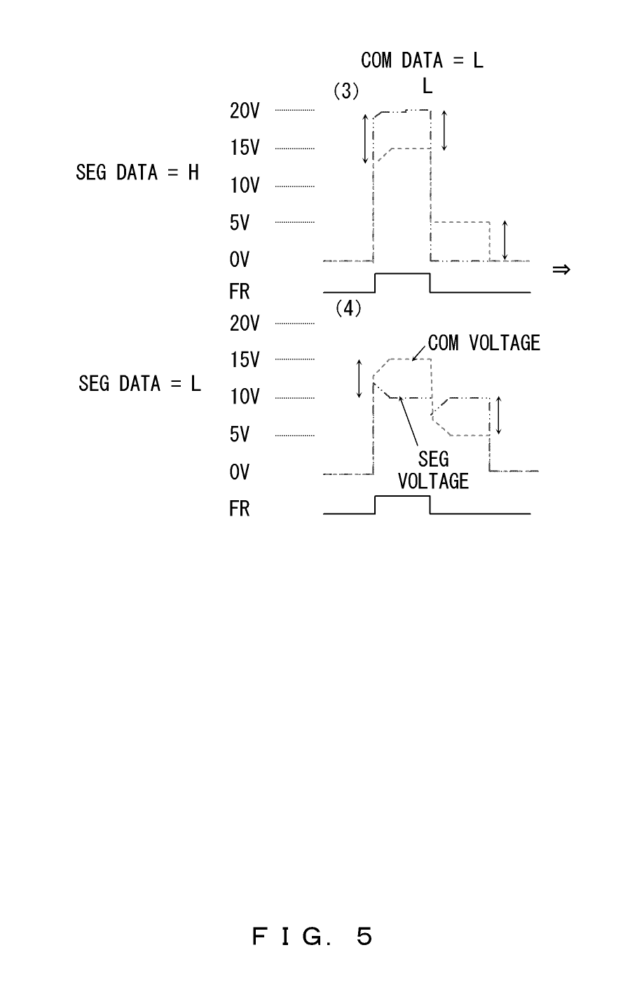

FIG. 5 illustrates the voltage drop and rise in the cases (3) and (4) when the three liquid crystal display panels 18a, 18b, and 18c of red (R), green (G), and blue (B) are displayed in synchronization.

As illustrated in FIG. 5, in both cases of (3) and (4), the COM voltage indicates a lager voltage drop or rise than the SEG voltage, and the potential difference between the SEG voltage and the COM voltage decreases or increases by a larger value than an expected value. For example, when V3 is 15V and V4 is 20V, the difference is 5V, but can actually be 6V or 7V.

In this state, when the case (4) (SEG data indicates “L”) occurs in most lines and the case (3) (SEG data indicates “H”) occurs in the minority, for example, when black characters are displayed with a white background, the potential difference by the voltage drop is added when the SEG data indicates “H”, and the voltage higher than the expected potential difference is applied to the liquid crystal, thereby badly affecting the display quality as the flicker on the screen by cross talk.

To protect against the problem above, the liquid crystal display panel according to the present embodiment inverts the pulse polarity control signal (FR) and inputs it for some of the plurality of liquid crystal display panels 18a through 18c. With the configuration in FIG. 1, the pulse polarity control signal (FR) is inverted by the inverter 22 and input to the common driver 19b and the segment driver 20b to be applied to the liquid crystal display panel 18c of blue (B) having the largest capacitance among the three liquid crystal display panels 18a, 18b, and 18c of red (R), green (G), and blue (B) so that the total capacitance of the panels whose pulse polarity control signal (FR) have been inverted and the total capacitance of the panels whose pulse polarity control signal (FR) have not been inverted can be close to each other.

The cases (3a) and (4a) in FIG. 4 illustrate the voltage levels on the segment (SEG) side and the common (COM) side in the above described case. The case (3a) in FIG. 4 corresponds to the case (3), and the case (4a) corresponds to the case (4).

In the case (3a) in FIG. 4, since the pulse polarity control signal (FR) indicates “L” in the first half of the process, and indicates “H” in the second half of the process, the COM voltage and the SEG voltage indicate inverted values as compared with the case (3), that is, the COM voltage is V1 and the SEG voltage is V0 in the first half, and the COM voltage is V3 and the SEG voltage is V4 in the second half. Similarly in the case (4a), the voltages indicate inverted values as compared with the case (4), that is, the COM voltage is V1 and the SEG voltage is V2 in the first half, and the COM voltage is V3 and the SEG voltage is V2 in the second half.

Therefore, in the liquid crystal display device 1 according to the present embodiment, since the COM voltage applied to the three liquid crystal display panels 18a, 18b, and 18c is dispersed between V1 and V3 in both cases (3) and (4), the voltage drop can be decreased. In addition, since the supplied voltage is stable, the flicker of the display screen can be reduced.

Furthermore, it is not necessary to further provide a control signal to realize a simple configuration by only adding an inverter to a part of the pulse polarity control signal (FR). In addition, the synchronization of each liquid crystal display panel 18 is not changed, but only the pulse polarity control signal (FR) is partly inverted, thereby avoiding a color discrepancy. Furthermore, no complicated control is required.

In addition, since there occurs a small voltage drop when the polarity of the pulse polarity control signal (FR) is changed, a desired voltage can be applied to the liquid crystal display panel 18, thereby improving the display characteristic.

In the example above, the pulse polarity control signal (FR) to be input to the drivers 19b and 20b of the blue liquid crystal display panel 18b in the configuration of a combination of three liquid crystal display panels 18a, 18b, and 18c of red (R), green (G), and blue (B) is inverted. However, the liquid crystal display device 1 according to the present embodiment is not limited to this configuration.

For example, in the example described above, the input of the pulse polarity control signal (FR) to the drivers 19b and 20b of the blue liquid crystal display panel 18b is inverted, but on the contrary the input of the pulse polarity control signal (FR) to the drivers 19a and 19c and 20a and 20c of red (R) and green (G) can be inverted.

In addition, in the example above, the liquid crystal display panels 18 of red (R), green (G), and blue (B) have been used, but the liquid crystal display panels 18 of other colors can be used. In this case, the inverted input and the non-inverted input of the pulse polarity control signal are to be selected so that the sum of each capacitance is closer to each other.

Furthermore, in the example above, three liquid crystal display panels 18 are provided, but the number of liquid crystal display panels 18 can be two, four, or more. In this case, the inverted input and non-inverted input of the pulse polarity control signal are to be selected so that the sum of each capacitance is closer to each other.

What is claimed is:

1. A liquid crystal display device, comprising:
a plurality of liquid crystal display panels of simple matrix;
a plurality of driver units, provided as associated with the plurality of liquid crystal display panels, to apply a driving voltage to the liquid crystal display panels;
a control unit to output a pulse polarity control signal (FR) for converting a driving voltage applied to the liquid crystal display panels by the driver unit to an alternative current voltage; and
an inverter unit to invert the pulse polarity control signal (FR) output by the control unit and to input the inverted signal to the driver unit corresponding to at least one of the plurality of liquid crystal display panels.

2. The display device according to claim 1, wherein
the inverter unit inputs the pulse polarity control signal (FR) without invert to the driver unit corresponding to the liquid crystal display panel to which a pulse polarity control signal (FR) inverted the pulse polarity control signal (FR) output by the control unit is not input.

3. The display device according to claim 1, wherein
the liquid crystal display panel corresponding to the driver unit to which the pulse polarity control signal (FR) inverted by the inverter unit is input is selected based on a capacitance of the liquid crystal display panel.

4. The display device according to claim 1, wherein
the plurality of liquid crystal display panels are cholesteric liquid crystal display panels of red, green and blue.

5. The display device according to claim 4, wherein
the inverter unit inputs the inverted pulse polarity control signal (FR) to the driver unit corresponding to a liquid crystal display panel which has a largest capacitance in the liquid crystal display panels of red, green, and blue.

6. The display device according to claim 5, wherein
the inverter unit inputs the inverted pulse polarity control signal (FR) to the driver unit corresponding to the blue liquid crystal display panel, and inputs the pulse polarity control signal (FR) without invert to the driver units corresponding to the red liquid crystal display panel and the green liquid crystal display panel.

7. A control method for a liquid crystal display device comprising a plurality of liquid crystal display panels of simple matrix, and a plurality of driver units, provided as associated with the plurality of liquid crystal display panels, to apply a driving voltage to the liquid crystal display panels, the method comprising:
inverting a pulse polarity control signal (FR) for converting the a driving voltage applied to the liquid crystal display panels by the driver units to an alternative current voltage; and
inputting the inverted signal to the driver unit corresponding to at least one of the plurality of liquid crystal display panels.
